(19) United States
(12) Patent Application Publication
(10) Pub. No.: US 2017/0228959 A1
(43) Pub. Date: Aug. 10, 2017

(54) VENDING MACHINE FOR SELECTED QUANTITIES OF DISTINCT PERFUMES

(71) Applicant: Dimitrios BOTHOS, Glyfada Attikis (GR)

(72) Inventor: Dimitrios BOTHOS, Glyfada Attikis (GR)

(21) Appl. No.: 15/503,421

(22) PCT Filed: Aug. 13, 2014
(86) PCT No.: PCT/GR2014/000045

§ 371 Date: Feb. 13, 2017

(51) Int. Cl. G07F 13/06; B67D 7/80; G07F 9/10; B67D 7/02

(52) U.S. Cl. CPC G07F 13/06; B67D 7/0288; B67D 7/80; G07F 9/105

(57) ABSTRACT

A vending machine for dispensing selected quantities of distinct perfumes comprises a plurality of containers (70) stored within an air-cooled compartment (3), each container filled with a distinct perfume, a plurality of independent perfume supply circuits assigned to circulation of each distinct perfume comprising one container (70) containing this distinct perfume, a pump (80) assigned to pumping this perfume, the pump connected by means of a flexible pipe (81) to the container (70) and by means of a flexible pipe (82) to one of an equivalent plurality of tubular needles (83) assigned to supplying this distinct perfume. Rotatable perfume bottling assembly units (50) comprising a circumferential arrangement of tubular needles (83) are provided with associated perfume bottle filling drive units (90) adapted to handle delivery of a desired distinct perfume from a specific container (70) into a bottle (41) in a perfume purchase operation.

### THE FIELD OF THE ART

The present invention is directed to a vending machine adapted to be operated by customers of perfume stores and provide, either with the aid of a store attendant or through a customer operated prepayment mechanism, a selected quantity of a predetermined range of quantities of selected distinct perfumes.

### THE BACKGROUND OF THE INVENTION

Vending machines providing selected blends of liquids are known in the prior art. Vending machines selling coffee and other hot or cold beverages, as well as other liquid products including perfumes are broadly used.

GB-2433735 to Warrick discloses a coin operated perfume vending machine that is securely mounted onto a wall and a user has to pull a handle, after having inserted a coin, in order to activate discharge of a spray of perfume from an outlet nozzle of the machine into his hand.

DE-4138004 discloses a perfume dispenser that automatically dispenses a range of perfume types. It contains a number of perfume reservoirs, a coin mechanism, a membrane air pump, a spray nozzle, an air reservoir and a control mechanism with an electromagnetic drive to the spray nozzle.

U.S. Pat. No. 5,893,487 to Little discloses a fluid dispensing system comprising a tank for a fluid and a vessel having a restricted entry aperture for extracting a quantity of the fluid from the tank and for directing the extracted fluid to one or more selected receptacles. In use, the vessel is adapted for rotary passage through the tank, whereby, during a rotary cycle of the vessel, air exhausts through an outlet pipe positioned exteriorly of the tank as fluid ingresses into the vessel through the aperture in a filling operation, whereas air flows through the aperture as fluid is dispensed through the outlet pipe in a dispensing operation.

Further coin operated machinery has been developed for delivering blends of distinct scents. WO-02/05200 to the Procter and Gamble Company discloses a method, an apparatus and a composition for customizing the combination of fragrances. U.S. Pat. No.8,490,873 to Behbehani discloses a vending machine for dispensing selected blends of perfumes in response to the deposit of a pre-selected amount of money. The machine comprises a plurality of containers, each containing a particular distinct scent. The user selects desired quantities of one or more distinct scents and a mechanism is initiated for blending the selected scents in the selected percentages, providing a sample to the customer, receiving payment for a desired quantity of the blend and thereafter providing a bottle with the selected blend to the customer.

Prior art devices, although having revealed various machinery assemblies adapted to deliver perfumes, usually after payment of a specified amount through a coin operated mechanism, are confronted with a number of drawbacks associated with the equipment and the process employed in filling bottles of selected volume with a selected scent, such equipment and process adversely affecting the quality of the product delivered.

One drawback is related to the long term maintenance of the perfumes offered for sale under varying ambient temperatures that adversely affects the quality of the product. Further the maintenance of the perfumes within conventional commercially available containers that contain air and/or the use of air in bottle filling and dispensing operations as is the case with U.S. Pat. No. 5,893,487 also leads to deterioration of the perfume product, since the presence of air results in oxidation and gradual loss of the most volatile essential constituents of the perfume product. Furthermore the employment of air in perfume bottling and dispensing operations leads to an uncontrolled dispersion of varying odors of different perfumes bought by customers in the atmosphere, such multi-odorous atmosphere creating an undesired environment for the promotion of sales of varying distinct scents.

Yet another drawback of perfume vending machinery of the prior art that deliver a plurality of distinct scents is that a single motor/pump assembly and/or a single duct circuit connecting the plurality of distinct scent containing receptacles to the bottle filled with the selected scent at the point of delivery of the bottled perfume product is employed and this undoubtedly creates an issue of purity of the product being delivered, since the perfume bottling operation is being implemented with the same equipment for all successive sales of distinct scents. Furthermore the ordinary arrangement of bottle filling operations in perfume vending machinery of the prior art being performed within a specific predetermined period of time using timer controlled pumping means for specified selected varying quantities of perfumes being bought often leads to inaccuracies in the quantity of the final product being delivered.

### SUMMARY OF THE INVENTION

An object of the invention is to provide an air-free filling process of specially designed containers with the perfumes and storage of the same, thereby assuring a long term product quality that would be otherwise deteriorated due to oxidation occurring as a result of exposure thereof to ambient air and averting discharge of varying scents in the environment that would create an undesirable atmosphere of mixed odors. In this respect the invention proposes employment of perfume containers characterized by an enhanced elasticity that provides their air-tight self-sealing at all instances, whether they are thoroughly or partially filled with the perfume product, wherein this property of the perfume containers has been adequately tested and certified.

Another object of the invention is the employment of dedicated independent perfume supply circuits for administering a predetermined precise quantity of absolutely pure perfume from each one of the plurality of containers that contain an equivalent number of distinct perfumes to a bottle being placed within an appropriately designed perfume receiving slot provided onto the façade of the perfume vending machine of the invention, each independent perfume supply circuit assigned to circulation of a single distinct perfume and comprising its own pump and ducts for the delivery of perfume from each particular container to a bottle filled with the perfume contained in this container during a purchase operation of this particular perfume.

Another object of the invention is to provide a cooling system appropriate and efficient for the maintenance of the temperature of the perfume containers at desired levels ensuring a long term standard quality of the perfumes stored in the containers. In this respect a further object of the invention is to accomplish the housing wherein perfume containers are accommodated in such a manner as to ensure an efficient cooling of the specific compartment wherein the perfume containers are being stored.

Another object of the invention is to provide a smartly designed housing of the vending machine of the invention, which, whilst being of a size comparable to the size of ordinary known related machinery of the prior art, would nevertheless appropriately house the extended equipment of the machine of the invention that comprises the air-cooling system adapted to maintain the perfume containers at a desired relatively low temperature, as well as the plurality of independent perfume supply circuits, each with separate pump and duct means for each distinct perfume contained in each specific container and a plurality of perfume bottling assembly units and associated drive units thereof arranged to handle delivery of these distinct perfumes

A further object of the invention is to provide computer aided control of the entire process of selling selected quantities of selected distinct perfumes with the vending machine of the invention alternatively offered in the mode of perfume sale with the aid of a store attendant or in the mode of a customer operated prepayment mechanism for buying selected quantities of a predetermined range of quantities of selected distinct perfumes.

### BRIEF DESCRIPTION OF THE DRAWINGS

The invention will be best understood by those skilled in the art by reference to the accompanying drawings in which:

FIG. 1 shows a frontal perspective view of one embodiment of the perfume vending machine of the invention operated with the aid of a store attendant to deliver selected quantities of a predetermined range of quantities of selected distinct perfumes.

FIG. 2 shows a frontal perspective view of another embodiment of the perfume vending machine of the invention that includes a bill and coin insertion unit for automatic operation.

FIGS. 2a and 2b respectively show a detailed view of the bill and coin insertion unit and of the perfume bottle dispensing unit provided onto the frontal side of the vending machine of the invention.

FIG. 3a shows an exploded frontal perspective view of the housing of the perfume vending machine of the invention.

FIG. 3b shows an assembled frontal perspective view of the housing of the perfume vending machine of the invention.

FIG. 4a shows an exploded rear perspective view of the housing of the perfume vending machine of the invention.

FIG. 4b shows an assembled rear perspective view of the housing of the perfume vending machine of the invention.

FIG. 5 shows a rear perspective view of the housing of the perfume vending machine of the invention filled with the equipment that is employed to perform an automated provision of a selected perfume.

FIG. 6 shows a rear perspective view of the housing of the perfume vending machine of the invention showing the air cooling system adapted to maintain perfume containers at a desired temperature and the rack structure within the perfume container compartment with one perfume container illustratively mounted thereupon.

FIGS. 6a and 6b show illustrative views of a typical perfume container used in the vending machine of the invention.

FIG. 7 shows a perspective view of the rotating perfume bottling assembly unit adapted to perform a bottle filling operation with a selected perfume.

FIG. 7a shows a planar view of the rotating carrier of an array of tubular needles that constitutes part of the perfume bottling assembly unit of FIG. 7.

FIG. 7b shows an enlarged detailed view of the tubular needles provided on the circumference of the rotating perfume bottling assembly unit of FIG. 7.

FIG. 7c shows a side sectional view of the rotating perfume bottling assembly unit and of an adjacently located associated perfume bottle filling drive unit adapted to perform a downward stroke of one selected tubular needle from the array of tubular needles within a bottle mounted within a perfume dispensing unit during a filling operation of the bottle with a selected perfume flowing through the duct circuit that is specifically assigned to the perfume selected by the customer.

FIG. 8 shows a schematic diagram of a typical perfume supply circuit that is employed in the machine of the invention for a perfume bottling operation consisting in pumping a selected perfume from a container into a bottle.

FIG. 9 shows a diagram of successive monitor displays during a perfume vending operation.

### DESCRIPTION OF PREFERRED EMBODIMENTS OF THE INVENTION

The invention will be hereinafter described by reference to the illustrative embodiments presented in the accompanying drawings.

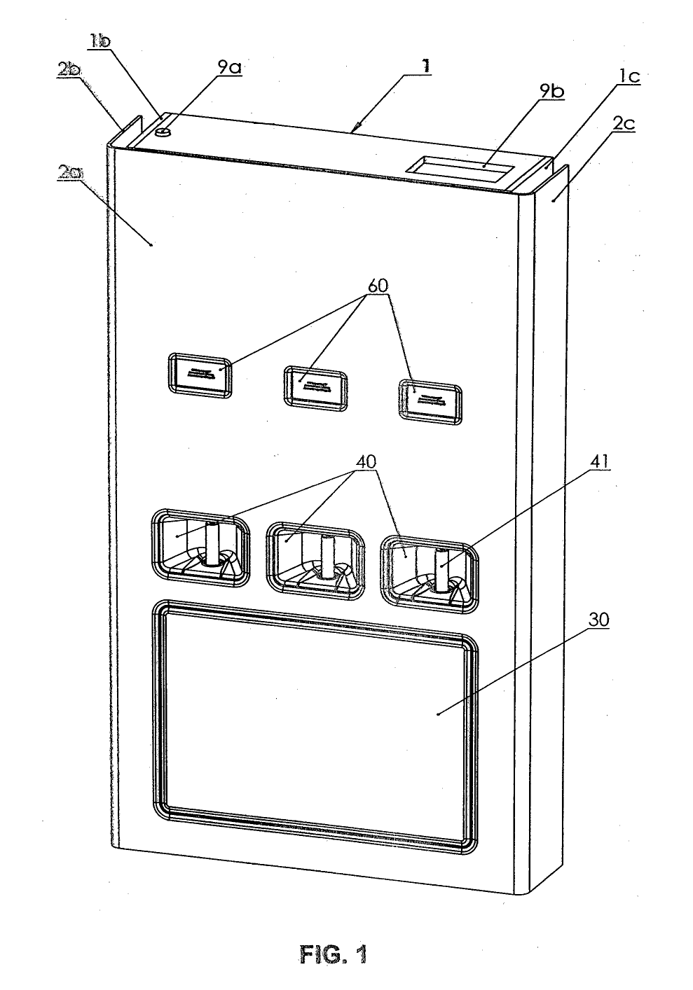

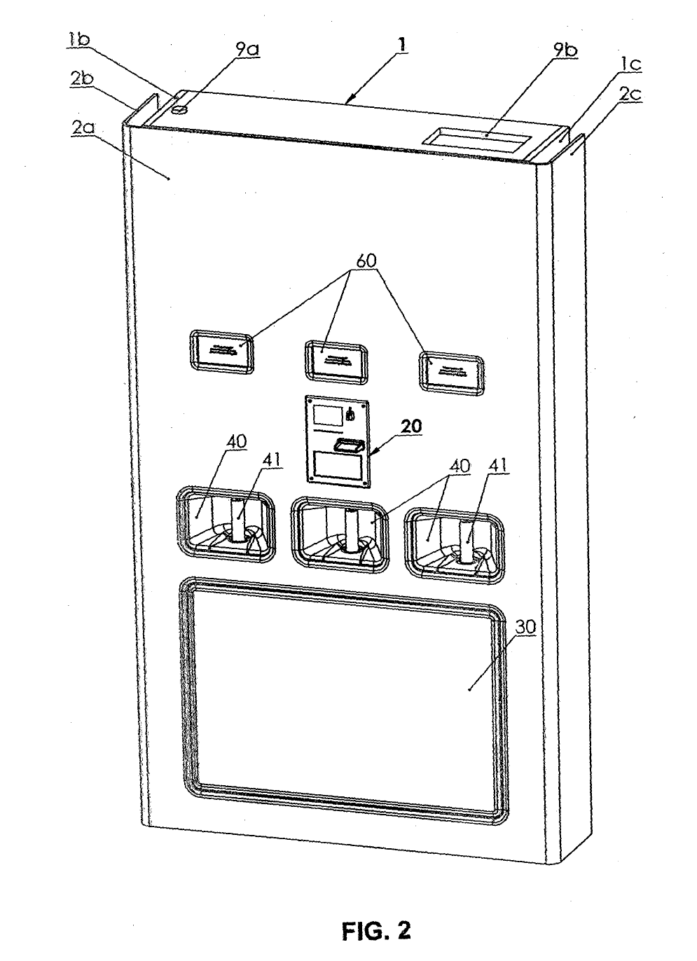

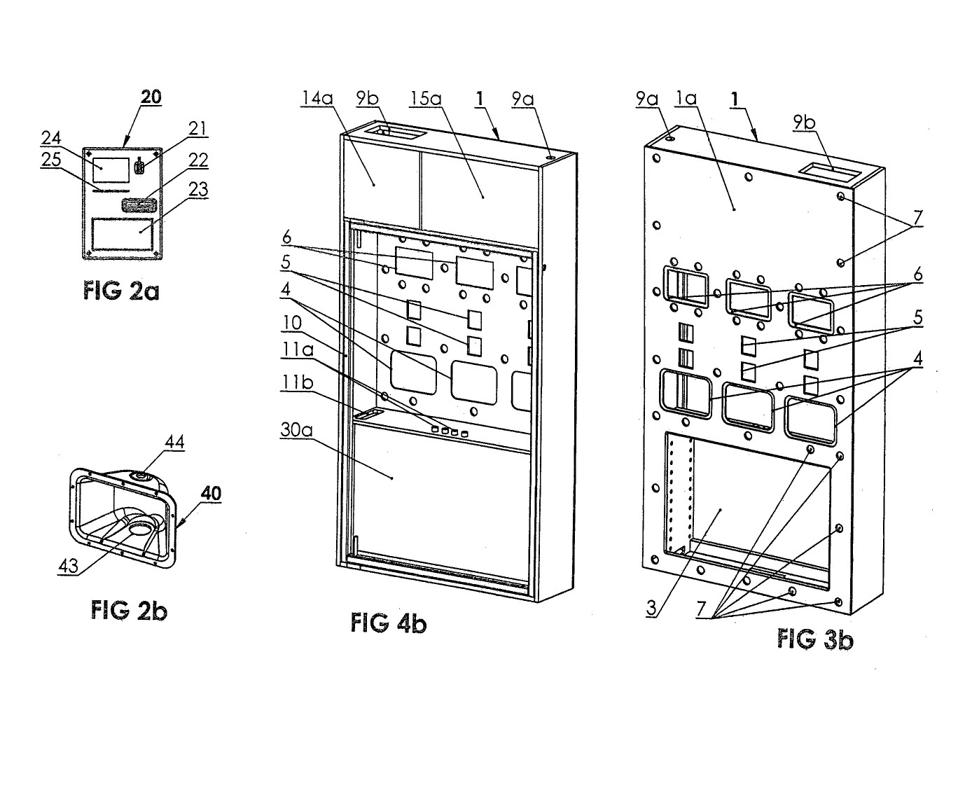

FIG. 1 shows a general frontal view of the perfume vending machine of the invention operated with the aid of a store attendant to deliver selected quantities of a predetermined range of quantities of selected distinct perfumes, whilst FIG. 2 shows a frontal perspective view of another embodiment of the perfume vending machine of the invention that includes a bill and coin insertion unit 20 for a perfume purchase operation without the aid of a store attendant.

As shown in FIG. 2a the bill and coin insertion unit 20 is provided with slots 21, 22 for the insertion of coins and bills respectively and with a cavity 23 wherein is being provided the change if any, equivalent to the difference between the sum of bills and coins introduced and the price of the perfume being purchased in case that the latter is less than the sum of bills and coins introduced. Further a display 24 is advantageously provided that monitors the total value of bills and coins introduced and/or the value of bills and/or coins to be further introduced in order to complete the purchase. Finally a slot 25 is shown underlying the display 24 whereby a receipt is being delivered to the customer after completion of the introduction of the bills and/or coins required for the purchase.

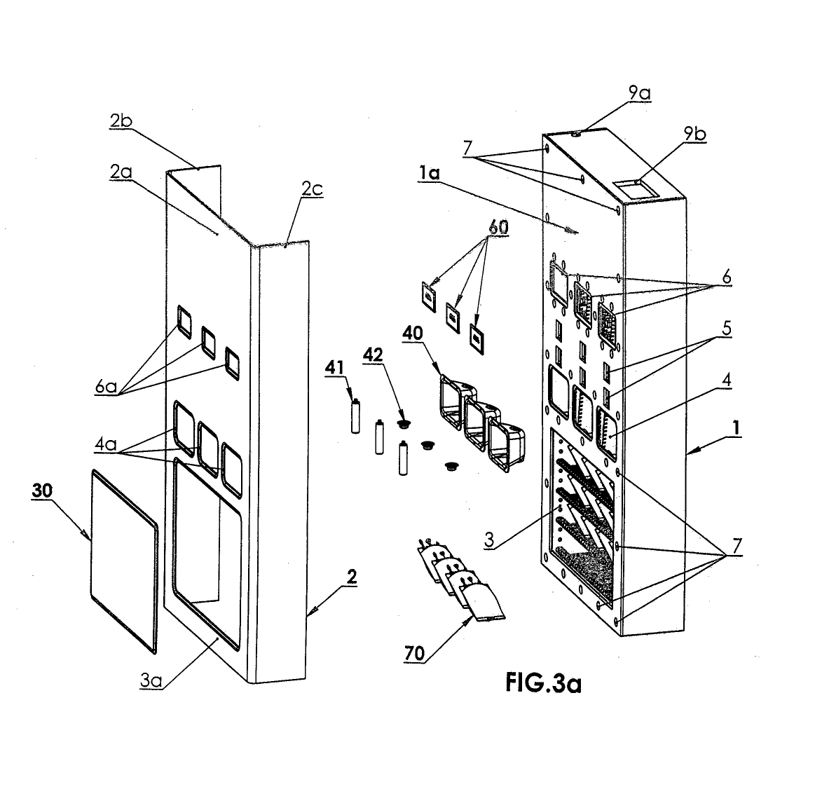

As shown in the exploded view of FIG. 3a, the perfume vending machine of the invention is accommodated within a generally parallelepipedal housing 1 with lateral sides 1b, 1c and a frontal side 1a comprising a bottom opening that reveals a perfume container compartment 3, a plurality of cavities 4 located above the opening of the perfume container compartment 3 and adapted to receive an equivalent number of perfume bottle dispensing units 40, a plurality of pairs of openings 5, each pair of openings 5 overlying a perfume bottle dispensing unit 40, such openings 5 allowing access into the rotating perfume bottling assemblies located within the housing 1 and a plurality of openings 6 adapted to mount an equivalent number of monitors 60 that provide to a customer a step-by-step process for selecting a desired perfume and buying a selected quantity thereof.

In accordance with a preferred embodiment of the invention, the frontal side 1a of the housing 1 is further provided with an appropriately spaced circumferential arrangement of holes 7 adapted to receive an equivalent number of protruding pins provided on the interior of a transparent facade 2 that is mounted onto the housing 1 with a scope of aesthetic perfection of the machine.

The transparent facade 2 is by way of example being made from a solid transparent plastic, e.g. Plexiglas or other appropriate material, and comprises a frontal side 2a and side flanges 2b, 2c that extend bilaterally beyond the housing 1 of the machine so as to provide a gap in between said side flanges 2b, 2c and the corresponding lateral sides 1b, 1c of housing 1 (FIGS. 1, 2) wherein appropriate lighting units might be mounted within the aforementioned gaps. Further, the frontal side 2a of the transparent facade 2 is provided with an opening 3a that is of a size equivalent to the size of the opening of housing 1 revealing the perfume container compartment 3, a series of openings 4a that correspond to the openings 4 of housing 1 wherein the perfume bottle dispensing units 40 are mounted and a series of openings 6a overlying openings 4a and corresponding to the openings 6 of housing 1 wherein the monitors 60 are mounted. A gate 30 is provided to air-tightly close the opening 3 of housing 1, such gate 30 being adapted to slide upwardly by means of bilateral sliding mechanisms thereby revealing the perfume container compartment 3.

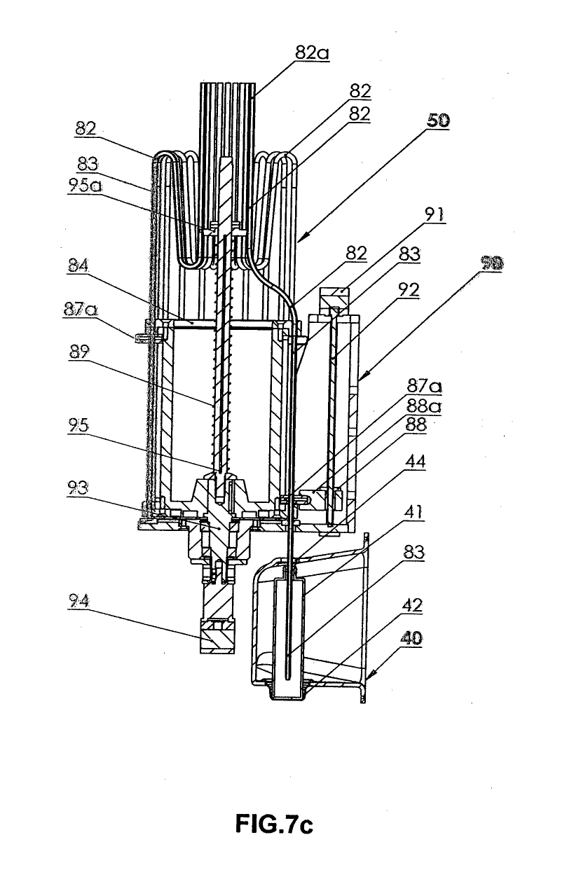

FIG. 2b shows a detailed view of a perfume bottle dispensing unit 40 provided onto the frontal side of the vending machine of the invention. The perfume bottle dispensing unit 40 is a curvilinear body with a flat open frontal side, such bottle dispensing unit 40 being mounted on the frontal side of the housing 1 of the machine of the invention with the flat open side abutting on the frontal side 1a of the housing 1 and corresponding frontal side 2a of the transparent façade 2, such open side revealing an opening wherein a bottle 41 is being introduced in order to be filled with a selected perfume. The perfume bottle dispensing unit 40 is provided with a bottom cavity 43 adapted to receive alternative forms of a cup 42 (FIG. 3a, FIG. 7c) appropriately configured to match the form of the bottom of the bottle 41 that is being inserted within the perfume bottle dispensing unit 40 and sits onto such cup 42 in a perfume bottling operation. By way of example, cup 42 might be rectangular or circular to receive a bottle 41 having a rectangular or circular bottom respectively. An opening 44 is provided at the top of the perfume bottle dispensing unit 40, axially above the bottom cavity 43, such opening 44 allowing introduction into the bottle 41 seated onto the cup 42 of a tubular needle that is used to supply the selected perfume into the bottle.

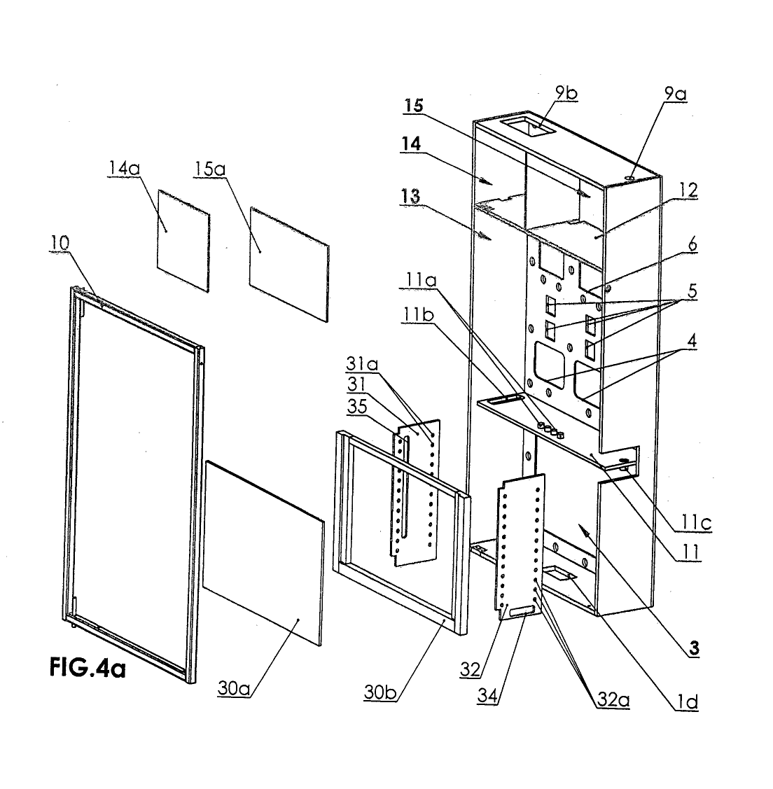

As shown in the exploded view of FIG. 4a, the rear of the generally parallelepipedal housing 1 of the perfume vending machine of the invention is provided with a pair of horizontally extending planks 11, 12, whereby a lower plank 11 defines the upper ceiling of the opening adapted to house the perfume container compartment 3, whilst an upper plank 12 located underneath the top of the housing 1 defines a chamber 14 housing the condenser 16 and the compressor 17 of an air cooling system and an adjacent chamber 15 that houses the electrical/electronic circuitry of the vending machine of the invention. Appropriately dimensioned detachable covering panels 14a, 15a are used to cover corresponding chambers 14, 15. A chamber 13 is provided in between the horizontally extending planks 11, 12, wherein chamber 13 houses the rotating perfume bottling assemblies 50 used in the bottling operation of filling a selected bottle 41 with a selected perfume derived from the perfume containers 70 stored within the perfume container compartment 3.

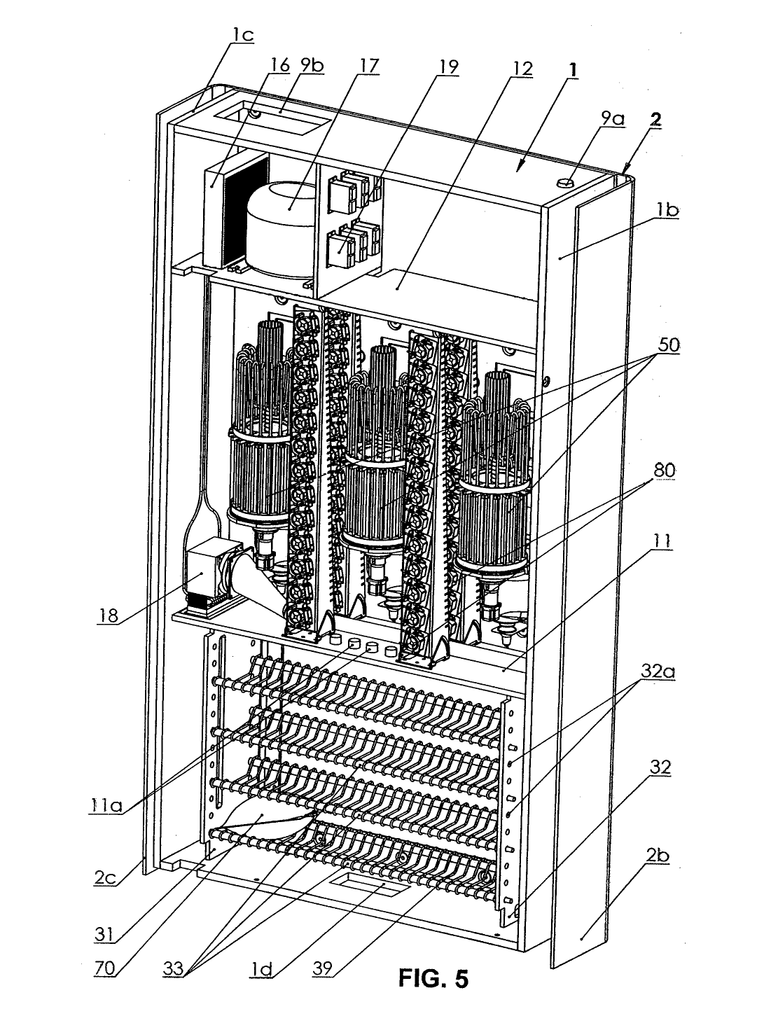

A pair of planks 31, 32 is employed to define the vertically extending lateral walls of the perfume container compartment 3. Each plank 31, 32 is provided with vertically extending arrays of appropriately spaced openings 31a, 32a respectively. A plurality of tubes 33 (FIG. 5) are used to define a plurality of equivalently spaced racks for mounting the perfume containers, each of these tubes 33 being mounted within selectively positioned axially opposing pairs of the abovementioned openings 31a, 32a. Furthermore, appropriate openings are being provided onto the vertically extending lateral walls 31, 32 of the perfume container compartment, such openings being adapted to allow air inlet and air outlet through the perfume container compartment 3. In accordance with a preferred embodiment of the invention an elongate opening 35 vertically extending from the bottom to the top of plank 31 and a transversal opening 34 close to the bottom of plank 32 are being provided to perform the required air circulation.

A frame 30b is mounted onto the pair of planks 31, 32, wherein frame 30b is adapted to receive a covering panel 30a that air-tightly closes the perfume container compartment 3 at the rear of housing 1. A plurality of perfume containers 70 are stacked onto the racks formed by the arrays of tubes 33 and by a plurality of wires 39 interconnecting each adjacently located pair of tubes 33 (FIG. 5). A rectangular metallic frame 10 is mounted at the rear of housing 1 extending underneath the upper plank 12 to the bottom of housing 1 and perimetrically surrounding chamber 13 of the rotating perfume bottling assemblies and the underlying perfume container compartment 3, such metallic frame 10 providing a reinforced structure that appropriately enables mounting of the housing 1 onto a wall surface.

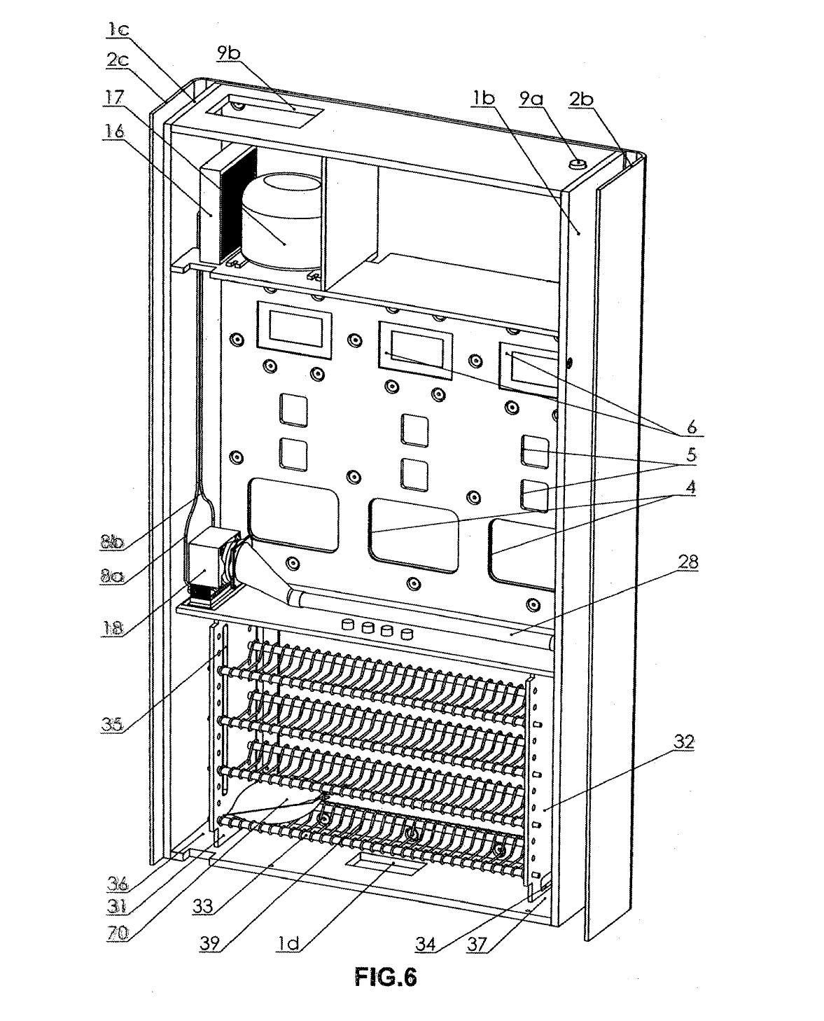

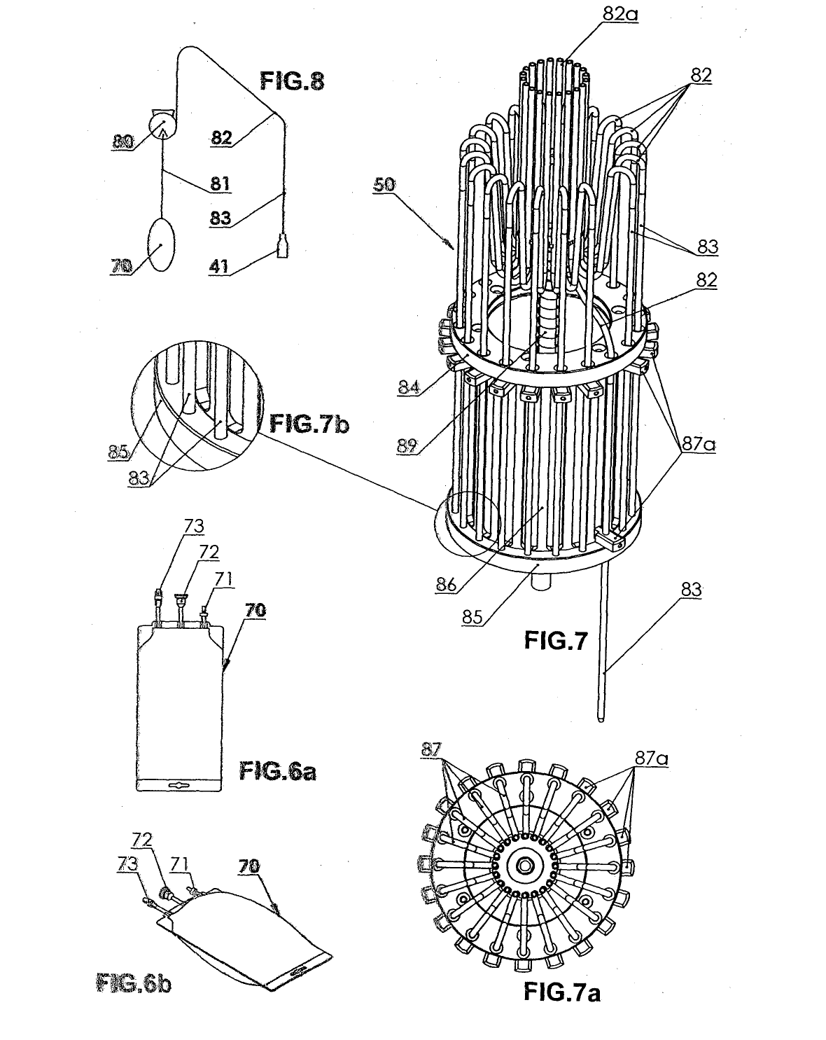

As shown in FIGS. 6a, 6b each perfume container 70 is made from a material of enhanced elasticity that ensures its automatic shrinking and sealing as it is being emptied from its contents thereby inhibiting the undesired ingress of air that would be detrimental to the quality of the perfume contained therein. Each perfume container 70 is provided with an appropriately tapped orifice 73 that is connected to a perfume supply source during filling of the container with perfume and to the perfume extracting equipment when the container after having being filled with perfume is introduced in the perfume container compartment 3 of the vending machine of the invention. Whilst empty, prior to its filling with a perfume product, the perfume container 70 is a flat entity comprising a pair of mutually abutting foils that constitute the walls thereof with no air in between, such foils being separated during the process of filling with perfume that has to be performed by an appropriate pump means that is being connected at the orifice 73 and feeds the fluid perfume product into the container under pressure, whereby the container gradually departs from its initial flat shape and obtains the shape depicted in FIG. 6b as it is being filled with the fluid perfume product. Each container 70 is further provided with another orifice 72 with an air suction filter that allows air discharge at all times thereby maintaining an air free storage of the perfume within the container. A further orifice 71 is provided with a self-sealing cotton plug that might be penetrated by a needle to provide a sample of the perfume contained in the container 70. As mentioned hereinabove each one of the perfume containers 70 is connected to a pipe of an independent duct circuit, such pipe being guided to the overlying rotating bottling assemblies 50. A series of openings 11a are provided onto the plank 11, i.e. onto the ceiling of the perfume container compartment 3, whereby a plurality of pipes 81, each pipe 81 departing from the perfume supply orifice 73 of each one of the containers 70 and being led through these openings 11a into the overlying perfume bottling chamber 13 to be subsequently connected to the perfume bottling assemblies as will be described hereinafter.

A pair of openings 9a, 9b is provided at the top of the housing 1, such openings constituting the inlet and/or outlet ports of the air that enters the interior of the housing 1 and is used to provide ventilation of compartments 13, 14, 15 accommodating the perfume bottling assembly units 50, the condenser and compressor units of the air cooling system used for maintaining the perfume containers at a desired predetermined relatively low temperature and the electrical/electronic equipment respectively.

A closed circuit air cooling system is employed for maintaining the perfume containers within the lower compartment 3 at a desired predetermined relatively low temperature of the order of 10° C. thereby affording the advantages referred to in the introductory chapter of the present. As mentioned hereinabove the compartment 3 is closed in an air tight manner with panel 30b at the rear of the housing 1 following completion of the rack structure, loading of a predetermined number of perfume containers 70 thereupon, each containing a distinct perfume and extracting through the openings 11a the plurality of pipes 81 each deriving from each one of the containers 70 to be led to the perfume bottling assemblies in the overlying compartment 13. Access into the compartment 3 is thereafter being made through the frontal sliding gate 30 of the housing. When the pair of planks 31, 32 defining the vertically extending lateral walls of the perfume container compartment are put in place, they are distant from the adjacent lateral walls of the housing 1, so as to form vertically extending channels 36, 37 respectively wherein air flows as will be described hereinafter. As shown in FIG. 4a, a transversal opening 11b is provided at one end of plank 11 and a round opening 11c is provided at the other end thereof, such openings 11b, 11c being respectively employed to lead air cooled through the air cooling system downwardly into channel 36 and to lead air that has passed through the compartment 3 upwardly into channel 37 back into the air cooling system.

In accordance with a preferred embodiment of the invention, the closed circuit air cooling system employed for maintaining the perfume containers at a desired predetermined relatively low temperature comprises the condenser 16 and compressor 17 housed within the upper compartment 14 of the housing 1 and an evaporator/exchanger unit 18 mounted onto the lower horizontally extending plank 11 that forms the ceiling of the perfume container compartment 3 in a manner such as to ensure that the air discharged through this evaporator/exchanger unit 18 is being led through the abovementioned transversal opening 11b at one end of plank 11 within the abovementioned channel 36 in between the lateral wall 1c of housing 1 and the vertically extending lateral wall 31 of the perfume container compartment 3. A piping network 8a, 8b wherein flows a refrigerant medium, e.g. Freon, connects the condenser 16 to the evaporator/exchanger unit 18 and as a result air flowing in the evaporator/exchanger unit 18 is cooled and is discharged downwardly through the transversal opening 11b provided onto the plank 11, whereby a cool air stream is provided within channel 36 formed in between the lateral wall 1c of the housing 1 and the vertically extending lateral wall 31 of the perfume container compartment 3, the air being subsequently introduced into compartment 3 through the elongate opening 35 of the vertically extending lateral wall 31 thereof, as well as through the openings 31a of the latter, whereby after having passed through the perfume containers 70 stacked within compartment 3, air being discharged through the transversal opening 34 located close to the bottom of the vertically extending lateral wall 32 of the perfume container compartment 3, as well as through the openings 32a thereof, into the channel 37 formed in between the lateral wall 1b of the housing 1 and the vertically extending lateral wall 32 of the perfume container compartment 3, whereby it is being sucked into a duct 28 that is oriented longitudinally along plank 11 with one funnel-shaped end connected to the evaporator/exchanger unit 18 and its other end fitted onto the round opening 11c of plank 11, whereby the air having an increased temperature after having passed through the perfume container compartment 3 is being guided through the duct 28 back into the evaporator/exchanger unit 18 wherein it is being cooled and driven again downwardly to perform another cooling cycle of the perfume containers 70 stacked within perfume container compartment 3. It is herein noted that an appropriately tapped opening 1d is provided at the bottom of the housing 1, such opening being used to periodically remove possible matter of condensates formed within the perfume container compartment 3 during the cooling thereof.

In an illustrative example of the invention, a total of sixty containers 70, each containing a distinct perfume are being stored within the perfume container compartment 3, a pipe 81 being connected at the orifice 73 of each perfume container 70, whereby a total of sixty pipes 81 is provided within the perfume container compartment 3, such pipes being grouped in bundles and guided through the openings 11a at the top plank 11 of compartment 3 to pass into the overlying compartment 13 with the perfume bottling assemblies. In accordance with a preferred embodiment of the invention pipes 81 are being assembled in groups of fifteen pipes, thereby forming four bundles of pipes 81, each bundle passing through one of the four openings 11a into the overlying perfume bottling compartment 13.

A diagrammatic illustration of a typical perfume supply duct circuit that is employed in the machine of the invention for a perfume bottling operation is shown in FIG. 8, such perfume bottling operation consisting in pumping a selected perfume from a specific container 70 stacked within the container compartment 3 into a bottle 41 that has been placed within a perfume dispensing unit 40 at the front of the vending machine of the invention. A typical perfume supply duct circuit therefore comprises a perfume container 70 filled with a distinct perfume within a set of sixty containers filled with distinct perfumes accommodated within the perfume container compartment 3, a pipe 81 connected at the orifice 73 of the perfume container 70 and being guided to a pump 80 within a set of sixty pumps, each one of the sixty pumps 80 being assigned solely to the pumping and delivery of one specific distinct perfume contained within one specific perfume container 70, a flexible pipe 82 emanating from a pump 80 and being led to a perfume bottling assembly 50 wherein it is being connected to a single, accordingly unique for this specific flexible pipe 82, tubular needle 83, by means of which a selected quantity of this perfume is being discharged into a bottle 41 being placed within a perfume bottle dispensing unit 40. It is being evident from the above that in accordance with a preferred embodiment of the invention sixty distinct perfume supply duct circuits are employed with sixty distinct containers 70, sixty pipes 81 connecting the sixty distinct containers 70 to sixty pumps 80, each pump 80 uniquely assigned to one distinct perfume and connected through a duct 82 of a plurality of sixty ducts 82 to a tubular needle 83 of a plurality of sixty perfume supplying tubular needles 83, each tubular needle 83 uniquely assigned to a single distinct perfume. It is therefore evident that employment of sixty completely independent perfume supply duct circuits in the vending machine of the invention ensures delivery of an absolutely pure quantity of each distinct perfume selected by a customer among the plurality of distinct perfumes available in the vending machine of the invention.

As shown in FIG. 5 three identical rotating perfume bottling assembly units 50 are provided in the illustrative embodiment of the invention adapted to deliver a total of sixty distinct perfumes, each distinct perfume being pumped from this container of the array of sixty distinct containers 70 that is uniquely associated to the specific distinct perfume.

These three identical rotating perfume bottling assembly units 50 are adjacently mounted within the compartment 13 of the vending machine, each one of these three perfume bottling assembly units 50 being adapted to deliver twenty distinct perfumes. An equivalent number of pumps 80 adapted to provide supply of each one of the sixty distinct perfumes being provided are stacked in columnar arrays in between the three identical rotating perfume bottling assembly units 50.

As shown in the illustrative perspective view of one such perfume bottling assembly 50 presented in FIG. 7, a perfume bottling assembly unit 50 of the invention comprises a cylindrical body with an upper annular flange 84, a lower annular flange 85 and a corrugated circumferential surface 86 providing twenty successive grooves wherein are nested twenty tubular needles 83 as shown in the detail of FIG. 7b, each tubular needle 83 being adapted to deliver a single distinct perfume of a set of twenty distinct perfumes delivered by one such perfume bottling assembly 50.

A carrier of the tubular needles 83 illustratively shown in FIG. 7a is provided underneath the abovementioned upper annular flange 84, such carrier being a circular array of equivalently sized radially extending arms 87 with clamps 87a at the ends thereof, each clamp 87a firmly holding one of the tubular needles 83 and adapted to slide within one of the abovementioned twenty successive grooves of the corrugated circumferential surface 86 of the cylindrical body portion of the perfume bottling assembly 50. Each perfume supplying tubular needle 83 passes through one of twenty equidistantly spaced holes at the circumference of the lower annular flange 85 to perform a downward stroke through the abovementioned upper opening 44 of a perfume bottle dispensing unit 40 as shown in FIG. 7b, thereby being guided close to the bottom of the bottle 41 placed therein. Accordingly, each perfume supplying tubular needle 83 passes through one of twenty equidistantly spaced holes at the circumference of the upper annular flange 84 and extends upwardly at a length equivalent to the length of the tubular needle 83 that is being driven downwardly into the bottle 41 and close to the bottom thereof. Flexible pipes 82 are connected at the free ends of the tubular needles 83 extending upwardly the upper annular flange 84, such pipes being thereafter grouped into a vertically extending bundle 82a that comprises twenty identical flexible pipes 82, one for each one of the twenty distinct perfume supply circuits assigned to each perfume bottling assembly unit 50 of the vending machine of the invention, such flexible pipes 82 being thereafter connected to an equivalent number of pumps 80. A gear motor 94 is provided at the basement of the perfume bottling assembly 50, such gear motor providing a rotational movement of the cylindrical body with the corrugated circumferential surface 86 providing the twenty successive grooves wherein are nested the twenty tubular needles 83. A shaft 95 covered with a spiral spring 89 is mounted at a bearing 93 extending axially upwardly at the output of the gear motor 94 and beyond the cylindrical body in between the flexible pipes 82, wherein an annular flange 95a is provided that serves in providing appropriate support of the flexible pipes 82 by averting undesired entanglement thereof as they are being deployed to allow for the downward stroke of one tubular needle 83 each time during a perfume bottle filling operation.

FIGS. 7 and 7c show the clamp 87a of one tubular needle 83 having been displaced downwardly from a rest position close to the upper annular flange 84 to a position close to the lower annular flange 85, whereby an appropriate length of this tubular needle 83 extends beyond and downwardly the perfume bottling assembly 50 to be guided within a bottle 41 that has been mounted within a perfume dispensing unit 40 in order to be filled with the perfume corresponding to the supply circuit of this particular tubular needle 83.

As shown in FIG. 7c a perfume supply driving unit 90 is being provided adjacently each perfume bottling assembly unit 50. The perfume supply driving unit 90 comprises a vertically oriented screw 92 with a nut 88 adapted to move vertically along screw 92 as the latter is being rotated by a motor 91. A grab extension 88a of the nut 88 is adapted to engage with a clamp 87a of the particular tubular needle 83 that corresponds to the distinct perfume selected by the customer during a perfume purchase operation, thereby said grab extension 88a pulling downwardly this clamp 87a and leading this particular needle 83 to perform the downward stroke that results in a portion thereof extending below the lower annular flange 85 being immersed within the bottle 41 placed within the perfume dispensing unit 40 of the vending machine of the invention. During a perfume purchase operation, the electric drive gear motor 94 positioned at the basement of the perfume bottling assembly 50 that handles delivery of the particular perfume selected in this perfume purchase operation initiates a rotation of the cylindrical body thereof with a scope of bringing the tubular needle 83 that is assigned to the particular perfume selected by the customer in an operating position whereby grab extension 88a of the perfume supply driving unit 90 engages the clamp 87a at the end of this tubular needle 83 and pulls the latter downwardly into the bottle 41. The depth at which the vertically extending tubular needle 83 is being introduced into the bottle 41 is preferably selected to be close to the bottom of the latter so as to ensure a smooth flow of the perfume supplied by the tubular needle in a bottle filling operation. This depth is conveniently adjusted during the installation of the vending machine of the invention, wherein the authorized technician intervenes through each one of the plurality of pairs of openings 5 overlying the corresponding perfume bottle dispensing units 40, with a scope of adjustment of the stroke of the tubular needles associated with each one of the rotating perfume bottling assemblies 50, so that each tubular needle will reach a predetermined appropriate depth within a bottle 41 to ensure smooth flow of the perfume supplied therein.

As noted from the frontal perspective view of the machine of the invention, it comprises three monitors 60, each monitor 60 associated with a corresponding one of the rotating perfume bottling assemblies 50 and therefore being adapted to offer guided assistance for the purchase of any of the twenty perfumes deliverable by this perfume bottling assembly unit 50 that handles delivery of this particular group of perfumes. Each of the monitors 60, whilst at an idle condition wherein a perfume purchase operation has not been initiated, displays a series of tabs, each tab provided with identification particulars of a single distinct perfume. The potential customer first locates the monitor that provides the perfume he wishes to buy and then the particular tab leading to provision of this particular perfume. If the machine operates with the assistance of a store attendant, it is the store attendant who can guide the customer to the specific tab or else, if the machine operates without a store attendant, the customer may be guided to the particular tab with the aid of an alphabetical list of the perfumes or other appropriate guiding assortment.

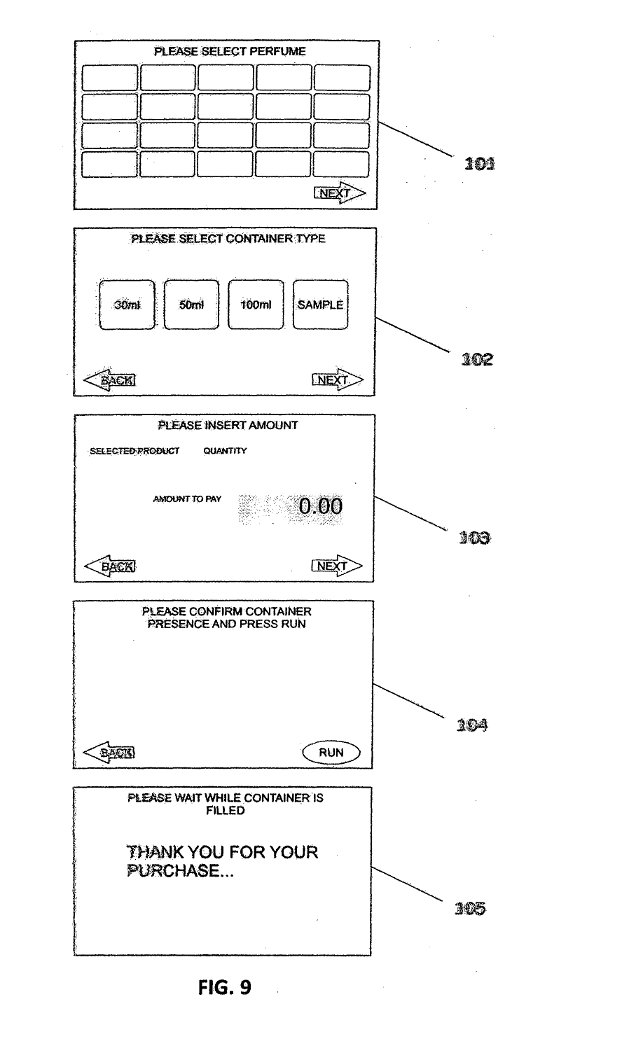

As shown in the illustrative process diagram of FIG. 9, after having located the monitor and tab corresponding to the particular perfume he wishes to purchase and whilst the monitor displays the message “PLEASE SELECT PERFUME” the customer may proceed to the first step 101 of the perfume purchase operation in which he may just touch the particular tab in a touch screen or enter a numeric code associated with the particular perfume in a supplementary keyboard and press a button labeled “NEXT” in order to initiate the process of purchase of the specifically selected perfume.

Then the monitor displays the message “PLEASE SELECT CONTAINER TYPE” and provides an indication of the container types available. In accordance with a preferred embodiment of the invention a series of tabs displays available container types with a capacity of 30, 50 and 100 ml. In addition a tab displaying the indication SAMPLE is provided. The customer then, during the second step 102 of the perfume purchase operation, proceeds in the selection of the container type and presses the button labeled “NEXT” in order to proceed to the next step.

Thereafter the monitor displays the message “PLEASE INSERT AMOUNT” and provides an indication of the perfume product selected in previous step 101, of the container type selected in previous step 102 and of the amount to be paid for the purchase of this particular perfume and quantity that has been selected. At this stage the customer may either confirm the purchase and proceed with payment or return to the previous screen (step 102) to change the container type or still to the previous screen (step 101) to change the perfume being selected by pressing a button labeled “BACK” available in either screen.

If the customer chooses to confirm the purchase particulars being displayed, payment is being effected either with the assistance of a store attendant who receives the money or credit card from the customer and issues a payment receipt with a cash register that is provided in the shop without being connected to the vending machine of the invention. Alternatively the customer may proceed with payment through the bill and coin insertion unit 20 if such is provided. In this case the customer sequentially inserts coins and bills in slots 21, 22 of unit 20 respectively and receives change if any through cavity 23 and payment receipt through slot 25 thereof.

Having fulfilled payment in step 103 of the perfume purchase process, the customer has to press the button labeled “NEXT” to be led to the next step 104, wherein the monitor displays the message “PLEASE CONFIRM CONTAINER PRESENCE AND PRESS RUN”. It is at this stage that the customer is provided with a container of the type that has been selected in step 102, such container either being handed to him by a store attendant or made available from a locked tray of containers provided adjacently to the vending machine of the invention. The customer has then to uncap the container and place it in the perfume bottle dispensing unit 40 that is being located axially below the specific monitor 60 handling this particular perfume purchase operation. In case of selection of a SAMPLE during the container type selection step, a small piece of appropriate paper carton is provided and placed within the same perfume bottle dispensing unit 40. After having placed this container within the perfume bottle dispensing unit 40 and having pressed the button labeled “RUN” during step 104 of the perfume purchase process, the monitor displays the message “PLEASE WAIT WHILE CONTAINER IS FILLED” and the perfume supply process is initiated (step 105), whereby either a few drops of the particular perfume are provided onto a sample paper carton or the specified perfume quantity is being provided through the perfume supplying tubular needle 83 part of the perfume supply circuit associated with this particular perfume. After completion of the perfume supplying process, the customer may remove the filled bottle from the perfume bottle dispensing unit 40 and appropriately cup it, whereby the monitor displays the message “THANK YOU FOR YOUR PURCHASE” that signifies successful completion of the purchase process. A self-adhesive tape containing indication of the perfume type and quantity that has been purchased and further identification particulars of the shop wherein the purchase was performed or further instructions of use of the perfume can be printed at the completion of a purchase process and delivered to the customer, who may stick such self-adhesive tape onto the bottle filled with the purchased perfume.

While hereinabove the invention has been described by reference to various preferred embodiments, it is to be appreciated that these are for illustrative purposes only and that those skilled in the art will realize that changes and modifications may be made thereto without departing from the spirit of the invention; it is therefore intended to include such changes and modifications falling within the scope of the invention.

1. A vending machine for dispensing selected quantities of distinct perfumes in response to a deposit of a predetermined sum of money, said vending machine comprising a plurality of containers (70), each container filled with a distinct perfume of an equivalent plurality of distinct perfumes, said containers (70) accommodated within a bottom compartment (3) of a parallelepipedal housing (1) with a frontal side (1a) and lateral sides (1b, 1c), said frontal side (1a) of the housing (1) being provided with a series of perfume bottle dispensing units (40) and a series of monitors (60) displaying successive steps in a perfume purchase operation, said vending machine characterised by that it further comprises:
a plurality of perfume bottling assembly units (50), each comprising a plurality of tubular needles (83), each tubular needle (83) assigned with supplying one distinct perfume of said plurality of distinct perfumes, each one of said plurality of perfume bottling assembly units (50) being provided with an associated perfume bottle filling drive unit (90), each one of said perfume bottling assembly units (50) with the associated perfume bottle filling drive unit (90) being connected to a group of said plurality of containers (70) and adapted to handle delivery of the group of distinct perfumes contained in said group of said plurality of containers (70);
a plurality of independent perfume supply circuits, each independent perfume supply circuit assigned to circulation of a single distinct perfume and comprising one of said containers (70) that contains said distinct perfume, a pump (80) assigned to pumping said distinct perfume, a flexible pipe (81) connecting said pump (80) to said container (70) and a flexible pipe (82) connecting said pump (80) to one of said plurality of tubular needles (83) assigned to supplying said distinct perfume, and
a closed circuit air cooling system employed for maintaining the perfume containers (70) within said bottom compartment (3) at a predetermined relatively low temperature.

2. A vending machine for dispensing selected quantities of distinct perfumes in response to a deposit of a predetermined sum of money according to claim 1, further comprising a transparent facade (2) with a frontal side (2a) and side flanges (2b, 2c), said frontal side (1a) of the housing (1) being further provided with an appropriately spaced circumferential arrangement of holes (7) adapted to receive an equivalent number of protruding pins provided on the interior of said façade (2) being mounted onto the housing (1), said side flanges (2b, 2c) of said façade (2) extending bilaterally beyond the housing (1) so as to provide a gap in between said side flanges (2b, 2c) of said façade (2) and corresponding lateral sides (1b, 1c) of said housing (1), said frontal side (2a) of the facade (2) being provided with an opening (3a) sized in correspondence with said perfume container compartment (3), a series of openings (4a) that fit onto correspondingly sized openings (4) of housing (1) adapted to receive said perfume bottle dispensing units (40) and a series of openings (6a) that fit onto correspondingly sized openings (6) of housing (1) adapted to receive said monitors (60), wherein a gate (30) is provided to air-tightly close said opening (3a), said gate (30) being adapted to slide upwardly by means of bilaterally provided sliding mechanisms.

3. A vending machine for dispensing selected quantities of distinct perfumes in response to a deposit of a predetermined sum of money according to claim 1, further comprising a bill and coin insertion unit (20) provided with slots (21, 22) for the insertion of coins and bills respectively, a cavity (23) wherein change if any is being provided following completion of insertion of coins and bills within said slots (21, 22), a display (24) and a slot (25) whereby a receipt for the amount of money received is being extracted following completion of a perfume purchase.

4. A vending machine for dispensing selected quantities of distinct perfumes in response to a deposit of a predetermined sum of money according to claim 1, wherein each one of said perfume bottle dispensing units (40) is a curvilinear body with a flat open frontal side abutting on the frontal side (1a) of the housing (1) and an inner space adapted to receive a bottle (41) that is being introduced into said inner space in order to be filled with a selected perfume, a cavity (43) being provided at the bottom of said curvilinear body within said inner space adapted to receive a cup (42), said cup (42) having varying configurations to match the varying configurations of said bottle (41) being inserted therein, an opening (44) being provided at the top of said curvilinear body within said inner space, said opening (44) being located axially above said cavity (43) and adapted to allow introduction into said bottle (41) that is being introduced within said inner space and is vertically oriented between said cavity (43) and said opening (44) of the tubular needle (83) assigned with delivering within said bottle (41) one distinct perfume of said plurality of distinct perfumes selected by a customer in a perfume purchase operation.

5. A vending machine for dispensing selected quantities of distinct perfumes in response to a deposit of a predetermined sum of money according to claim 1, wherein said closed circuit air cooling system employed for maintaining the perfume containers (70) within said bottom compartment (3) at a predetermined relatively low temperature comprises a condenser (16) and compressor (17) housed within an upper compartment (14) of the housing (1) and an evaporator/exchanger unit (18) mounted onto a horizontally extending plank (11) that forms the ceiling of the perfume container compartment (3), said evaporator/exchanger unit (18) discharging cooled air through an opening (11b) of plank (11) into a channel (36) between a lateral wall (31) of said compartment (3) and said lateral side (1c) of the housing (1), whereby air enters through openings of said lateral wall (31) of said compartment (3) providing a cooling effect of said perfume containers (70) stacked therein and is discharged through openings of a lateral wall (32) of said compartment (3) located opposite to said lateral wall (31) into a channel (37) between said lateral wall (32) and said lateral side (1b) of the housing (1), wherein air is thereafter being sucked through an opening (11c) of plank (11) into a duct (28) back into said evaporator/ exchanger unit (18), pipes (8a, 8b) wherein flows a refrigerant medium being provided, said pipes (8a, 8b) connecting said condenser (16) to said evaporator/exchanger unit (18) to provide a cooling effect to the air flowing therein.

6. A vending machine for dispensing selected quantities of distinct perfumes in response to a deposit of a predetermined sum of money according to claim 1, wherein each said perfume bottling assembly unit (50) comprises a cylindrical body with an upper annular flange (84), a lower annular flange (85) and a corrugated circumferential surface (86) providing successive grooves, each one of said successive grooves nesting one of said tubular needles (83), a carrier of the tubular needles (83) comprising a circular array of equivalently sized radially extending arms (87), each arm (87) being provided with a clamp (87a) at the outer end thereof, each clamp (87a) being adapted to firmly holding one of said tubular needles (83) and slide within one of said successive grooves of the corrugated circumferential surface (86) of the cylindrical body portion of the perfume bottling assembly (50), each one of said tubular needles (83) passing through one hole of an array of equidistantly spaced holes at the circumference of said upper annular flange (84) and through one hole of an array of equidistantly spaced holes at the circumference of said lower annular flange (85), a gear motor (94) being provided at the basement of said perfume bottling assembly unit (50), said gear motor (94) providing a rotational movement of the cylindrical body with said plurality of tubular needles (83), said rotational movement being performed with a scope of bringing a tubular needle (83) assigned to delivery of a distinct perfume selected by a customer during a perfume purchase operation in proximity with said perfume bottle filling drive unit (90), said perfume bottle filling drive unit (90) comprising a vertically oriented screw (92) rotatable by a motor (91) and a nut (88) being adapted to move vertically along said screw (92) as it is being rotated by said motor (91), a grab extension (88a) of said nut (88) engaging the clamp (87a) of the tubular needle (83) brought in proximity with said perfume bottle filling drive unit (90), said grab extension (88a) pulling downwardly said clamp (87a) and leading said tubular needle (83) through said opening (44) of the perfume dispensing unit (40) into a bottle (41) that has been placed therein, whereby delivery of the selected perfume is performed through a perfume supply stroke of said pump (80) assigned to pumping said distinct perfume from said container (70) with said distinct perfume into said bottle (41).
